(19) United States
(12) Patent Application Publication
(10) Pub. No.: US 2026/0106188 A1
(43) Pub. Date: Apr. 16, 2026

(54) GAS SUPPLY APPARATUS

(71) Applicant: Robert Bosch GmbH, Stuttgart (DE)

(72) Inventors: Martin Dreizler, Stuttgart (DE); Steffen Derhardt, Gerlingen (DE)

(21) Appl. No.: 19/116,440

(22) PCT Filed: Aug. 4, 2023
(86) PCT No.: PCT/EP2023/071635

§ 371 Date: Mar. 28, 2025

(30) Foreign Application Priority Data
Sep. 30, 2022 (DE) 10 2022 210 428.5

(51) Int. Cl. H01M 8/04111; H01M 8/04082; H01M 8/04701

(52) U.S. Cl. CPC H01M 8/04111; H01M 8/04201; H01M 8/04708

(57) ABSTRACT

The invention relates to a gas supply apparatus (1) with a shaft (7) rotatably mounted about an axis of rotation (13) in a housing (15) and with a temperature control device (11) comprising a medium temperature control means (12) that surrounds the shaft (7) and is combined with a gas temperature control means (20).
In order to improve the gas supply apparatus (1) in terms of its functionality and/or it manufacturing method, the gas temperature control means (20) comprises at least two temperature control chambers (51, 52), which are connected to one another via a first temperature control path (61), which is connected in a temperature-controlling manner to at least one first component (71) to be temperature-controlled.

### BACKGROUND

The invention relates to a gas supply apparatus with a shaft rotatably mounted about an axis of rotation in a housing and with a temperature control device consisting of a medium temperature control means that surrounds the shaft and is combined with a gas temperature control means.

From the German disclosure DE 10 2018 201 162 A1, an air supply apparatus is known, which is configured as a turbo machine, in particular for a fuel cell system, with a compressor, a drive apparatus, and a shaft, wherein the compressor comprises an impeller arranged on the shaft, a compressor inlet, and a compressor outlet, wherein a working fluid is conveyable from the compressor inlet to the compressor outlet, wherein a drive cooling path for cooling the drive apparatus branches off at the compressor outlet. From the German publication DE 10 2014 224 774 A, a cooling unit of an air compressor is known, which contains a spiral housing, an impeller mounted on the spiral housing, and a motor driving the impeller and cools the motor and the bearings that support a rotary shaft of the motor using air at an outlet side of the impeller, wherein the cooling unit comprises the following: A plurality of coolant channels arranged along a radial direction in a motor housing coupled to the spiral housing and through which coolant flows; and a channel for cooled air configured between the coolant channels of the motor housing and through which air flows.

### SUMMARY

The problem addressed by the invention is to improve, in a functional and/or manufacturing-related sense, a gas supply apparatus with a shaft rotatably mounted about an axis of rotation in a housing and with a temperature control device consisting of a medium temperature control means that surrounds the shaft and is combined with a gas temperature control means.

In a gas supply apparatus with a shaft rotatably mounted about an axis of rotation in a housing, and with a temperature control device which comprises a medium temperature control means surrounding the shaft and combined with a gas temperature control means, the problem is solved by the gas temperature control comprising at least two temperature control chambers which are connected to one another via a first temperature control path which is connected in a temperature-controlling manner to at least a first component to be temperature-controlled. The two temperature control chambers enable a simple way to achieve at least two-stage temperature control, particularly cooling, of the gas, especially air, during operation of the gas supply apparatus. The claimed gas temperature control means enables the implementation of a multi-stage gas cooler, particularly an air cooler. The gas cooler, in particular the air cooler, can be used, for example, to cool heated air from a thrust bearing in the gas supply apparatus a second time before it is used in a further temperature control path, for example to cool an electric motor drive of the gas supply apparatus. In particular, this enables a very compact design, in which housing-side gas channels, in particular air channels, can advantageously be dispensed with from, for example, a left-hand side to, for example, a right-hand side of the gas supply apparatus, since the gas to be temperature-controlled, in particular the cooling air, can flow through a gap between a rotor and a stator of the electromotive drive of the gas supply apparatus. The gap between the rotor and the stator is traversed in an axial direction. The term “axial” refers to an axis of rotation of the shaft. “Axial” means in the direction of, or parallel to, this axis of rotation. Analogously, “radial” means transverse to this axis of rotation. The gas supply apparatus is, in particular, a compressor that is used in a fuel cell system to provide compressed air. The compressor can comprise an impeller. However, the compressor can also comprise multiple impellers. Alternatively or additionally, the compressor can be equipped with at least one turbine wheel. In that case, the compressor is also referred to as a turbo-compressor or turbo-machine. The electromotive drive of the gas supply apparatus preferably comprises an electromotive drive with a fixed stator in which a rotor is rotatably arranged. The claimed temperature control device is preferably used for cooling and is therefore also referred to as a cooling device. The temperature control device is a heat exchanger that consists of three components. A temperature control sleeve is an internal part. The gas temperature control ring constitutes a central part. The housing body constitutes an outer part. The cooling device with the inner part, the center part and the outer part is arranged in an annular space which is open radially inwardly of the electromotive drive, in particular a stator of the electromotive drive, and radially outwardly is bounded by a housing or an attached structure. At least one channel is formed between the inner part and the middle part, through which the temperature control medium, for example a water-glycol mixture, flows. Gas channels are formed between the middle part and the outer part, through which the gas to be temperature-controlled, particularly air to be cooled, flows.

A preferred exemplary embodiment of the gas supply apparatus is characterized in that the first component to be temperature-controlled comprises a thrust bearing that is designed as a gas bearing. Via the first temperature control path, the gas bearing can be advantageously supplied with gas, which serves to create a desired bearing effect in the gas bearing. The temperature-controlled gas easily enables the formation of a viable gas film in the gas bearing. The gas used is cooled favorably by the temperature control. Additional components to be integrated include, for example, two radial bearings, which are also designed as gas bearings. The bearings are used to support the shaft in the gas supply apparatus.

Another preferred exemplary embodiment of the gas supply apparatus is characterized in that at least two temperature control chambers are bounded by a common gas temperature control ring, along which a temperature control medium is guided radially on the inside. The temperature control medium is preferably a liquid. The gas to be temperature-controlled, in particular the air to be cooled, is prevented from coming into contact with the liquid that provides the temperature control medium by the gas temperature control ring.

Another preferred exemplary embodiment of the gas supply apparatus is characterized in that the at least two temperature control chambers comprise gas channels which run radially on the outside of the gas temperature control ring in a circumferential direction and are bounded axially by lamellar ribs which are angled away from a circular-cylinder-casing-like base body of the gas temperature control ring. Radially on the inside, the circular-cylinder-casing-like base body of the gas temperature control ring advantageously defines at least one medium channel through which the preferably liquid temperature control medium flows. The lamellar ribs on the outside of the gas temperature control ring act as a guide for the gas to be temperature-controlled. The gas channels are only flowed through with the gas to be temperature-controlled. The open guide structure, which is realized with the lamellar ribs on the gas temperature control ring, is advantageously closed off by a housing body. It is advantageous to provide pressure equalization gaps between the lamellar ribs and the housing body. This further improves the function of the gas temperature control means.

Another preferred exemplary embodiment of the gas supply apparatus is characterized in that the two temperature control chambers each include an inlet recess and an outlet recess connected by first and second gas channels. The inlet and outlet recesses are advantageously bounded radially on the outside of the housing body. Otherwise, the inlet recesses and the outlet recesses are advantageously bounded only by the gas temperature control ring. This considerably simplifies the production of the gas supply apparatus with multi-stage temperature control. Another aspect of the invention involves the gas to be temperature-controlled being supplied and discharged axially. This can further simplify the production of the gas supply apparatus with multi-stage temperature control.

Another preferred exemplary embodiment of the gas supply apparatus is characterized in that the gas temperature control ring has separating webs which delimit the inlet recesses and the outlet recesses and separate them from one another. One of the advantages of this is that no guide structures or separating structures for the gas have to be provided on the housing body, which forms the outer radial boundary of the gas channels. The housing body, which delimits the temperature control chambers with the gas channels radially on the outside, can be advantageously designed to be very simple. The housing body is advantageously in the form of a straight circular-cylinder casing, which can be manufactured cost-effectively.

Another preferred exemplary embodiment of the gas supply apparatus is characterized in that the at least two temperature control chambers comprise a first temperature control chamber which is connected to a gas pressure chamber of the gas supply apparatus via a gas supply path and which is connected to a second temperature control chamber via the first temperature control path, from which second temperature control chamber a second temperature-regulating path originates which is connected in a temperature control manner to at least one second component to be temperature-controlled. The second component to be temperature-controlled is, for example, a radial bearing that is used to support the shaft in the housing of the gas supply apparatus so that it can rotate. The claimed design of the gas supply apparatus with the two temperature control chambers and the two temperature control paths, particularly in conjunction with the claimed gas temperature control ring, enables an easy-to-implement multi-stage gas temperature control means.

Another preferred exemplary embodiment of the gas supply apparatus is characterized in that the second temperature control path extends between a rotor and a stator of the gas supply apparatus. The gas flowing through the second temperature control path has been effectively temperature-controlled, in particular cooled, in the second temperature control chamber. This can effectively improve the temperature control, in particular the cooling, of the electric motor drive of the gas supply apparatus.

Another preferred exemplary embodiment of the gas supply apparatus is characterized in that the first temperature control path has a branch, of which a first partial path extends to the second temperature control chamber, a second partial path being connected in a temperature-controlling manner to at least one third component to be temperature-controlled. The third component to be temperature-controlled is, for example, a second radial bearing with which the shaft is rotatably mounted in the housing of the gas supply apparatus. The flow or the flow of the partial paths with the gas can be easily adjusted, for example, via fluidic resistors. In this way the gas temperature control means is more effectively configured in the gas supply apparatus than with conventional gas supply apparatuses.

The invention also relates to a gas temperature control ring, a rotor, a stator and/or a housing for a gas supply apparatus as described above. The mentioned parts can be procured separately.

The invention also relates, as needed, to a fuel cell system with a gas supply apparatus as described above. The gas supply apparatus, preferably configured as an air supply apparatus, serves in the fuel cell system to compress air supplied to a fuel cell stack in the fuel cell system.

### BRIEF DESCRIPTION OF THE DRAWINGS

Further advantages, features, and details of the invention arise from the following description, in which exemplary embodiments are described in detail with reference to the drawings.

Shown are:

FIG. 1a: a schematic representation of a gas supply apparatus designed as a compressor, with a temperature control device that comprises a medium temperature control means combined with a gas temperature control means, according to a first exemplary embodiment, in longitudinal section;

FIG. 1b: the same illustration as in Figure la with arrows illustrating gas paths when the gas supply apparatus is in operation, according to a first exemplary embodiment;

FIG. 2: a perspective view of a gas temperature control ring of the gas supply apparatus shown in FIGS. 1a, 1b;

FIG. 3: a half-section of the gas temperature control ring;

FIG. 4: a schematic representation of the gas temperature control ring with a rectified two-stage gas temperature control means;

FIG. 5: the same representation as in FIG. 4 with a two-stage gas temperature control means in the opposite direction; and the

FIGS. 6 and 7: the same illustrations as in FIG. 1b with gas paths according to two further exemplary embodiments; and

FIG. 8: a similar representation to FIGS. 4 and 5 with three temperature control chambers.

### DETAILED DESCRIPTION

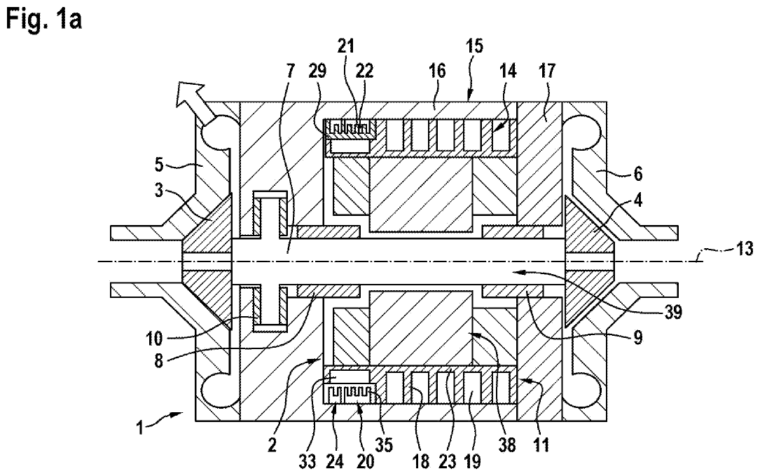

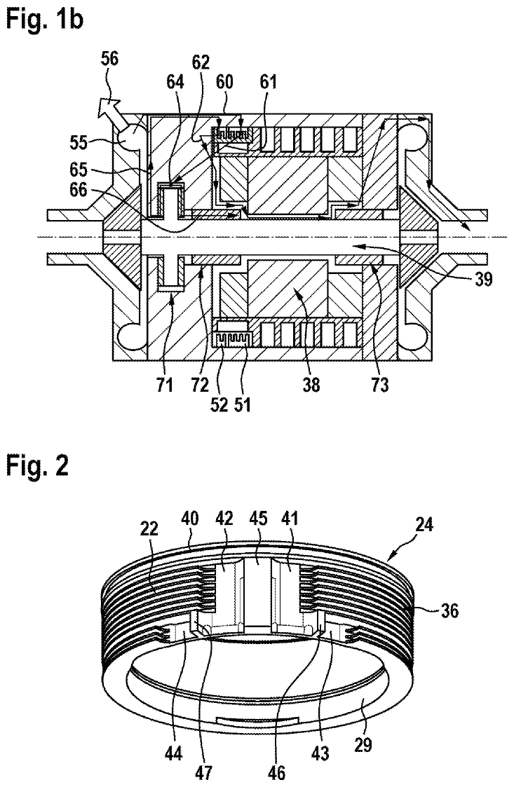

FIG. 1a schematically shows an air supply apparatus 1 in longitudinal section. The air supply apparatus 1 is configured as a compressor with two impellers 3, 4.

The impellers 3, 4 are configured as compressor wheels and are each arranged in a rotatable manner in a spiral housing 5, 6. The impellers 3, 4 are rotatably driven by an electromotive drive 2. The electromotive drive 2 comprises a stator 38 in which a rotor 39 is rotatably driven by a shaft 7.

The shaft 7 is rotatably mounted in a housing 15 with the aid of two radial bearings 8, 9 and one thrust bearing 10. The housing 15 comprises a housing body 16, which is designed in a substantially bowl-like manner. The bowl-like housing body 16 is closed by a housing lid 17. The housing 15, with the housing body 16 and the housing lid 17, is arranged in the axial direction between the two spiral housings 5, 6, which also form part of the housing 15.

The term “axial” refers to an axis of rotation 13 about which the shaft 7 with the two impellers 3, 4 is rotatably mounted in the housing 15. “Axial” means in the direction of, or parallel to, this axis of rotation 13. “Analog” means radially transverse to the axis of rotation 13.

The electromotive drive 2, in particular the stator of the electromotive drive 2, is surrounded in the housing 15 by a temperature control device 11 configured as a cooling device. The cooling device 11 is arranged in an annular space, which is bounded radially on the inside by the electromotive drive 2, in particular by the stator 38 of the electromotive drive 2.

The annular space in which the cooling device 11 is arranged radially outwardly is delimited by the housing body 16. In the axial direction, the annular space in which the cooling device 11 is arranged is delimited by the housing body 16 and the housing lid 17.

The cooling device 11 comprises a medium temperature control means 12 configured as a coolant cooling and a gas temperature control configured as an air cooling 20. The coolant cooling 12 is operated with a preferably liquid coolant, for example a water-glycol mixture. When the coolant cooling 12 is in operation, the temperature-controlled, preferably cooled, coolant flows through a cooling channel geometry 18 that is open radially outwards.

The cooling channel geometry 18, which is open radially outwards, includes a multiplicity of coolant channels 19, which are formed on an engine cooling sleeve 14. The cooling channel geometry 18 of the coolant cooling 12, which is open radially outwards, is largely limited by the housing body 16 and to a small extent by the air cooling 20.

The air cooling 20 also includes a cooling channel geometry 21 that is open radially outwards and has a multiplicity of gas channels, in particular air channels, 22. The radially outwardly open cooling channel geometry 21 of the air cooling 20 is bounded radially on the outside by the housing body 16.

The cooling channel geometry 18 of the coolant cooling 12 is radially bounded on the inside by a base body 23 of the engine cooling sleeve 14. Similarly, the cooling channel geometry 21 of the air cooling 20 is radially limited on the inside by a base body 29 of a gas temperature control ring 24. The base bodies 23, 29 each preferably essentially have the shape of straight circular cylinder casings.

In FIG. 1b, an arrow illustrates a gas supply path 60, a first temperature control path 61 and a second temperature control path 62. The gas supply path 60 starts from a gas pressure chamber 55. An arrow indicates a gas mass flow 56 that is supplied to a fuel cell that is not shown. The gas pressure chamber 55 is advantageously used to provide compressed air, which reacts in the fuel cell.

A portion of the compressed air is fed to a first temperature control chamber 51 via the gas supply path 60. The first temperature control path 61 extends from the first temperature control chamber 51 to a branch 64. The branch 64 is assigned to the first component 71 to be temperature-controlled. The first component 71 to be temperature-controlled is the thrust bearing 10.

At branch 64, the first temperature control path 61 splits into a first partial path 65 and a second partial path 66. Both partial paths 65 and 66 run along thrust bearing 10, which is the first component 71.

The first partial path 65 runs from the first component 71, i.e. the thrust bearing 10, into a second temperature control chamber 52. The second partial path 66 runs through a second component 72 to be temperature-controlled. The second component 72 to be temperature-controlled is the radial bearing 8.

A second temperature control path 62 extends through a gap, in particular an annular gap, which extends in the axial direction between the rotor 39 and the stator 38. In this exemplary embodiment, the second partial path 66 is combined with the second temperature control path 62 after the second component 72 to be temperature-controlled.

Part of the gas mass flow compressed by impeller 3 is used as cooling air via gas supply path 60. The larger part of the mass flow goes to the fuel cell system. The gas mass flow supplied via the gas supply path 60 is cooled down by the compressor outlet temperature at the gas temperature control ring 24 in the first temperature control chamber 51 until the gas mass flow has approximately reached the temperature of the liquid temperature control medium in the temperature control channel, in particular coolant channel.

The gas mass flow, which has been cooled down in the first temperature control chamber 51, is passed on to the thrust bearing 10 via the first temperature control path 61. This gas mass flow then splits into two partial mass flows at the branch 64. One of the partial mass flows is directed back to the gas temperature control ring 24 via the first partial path 65.

In the second temperature control chamber 52, this partial mass flow is cooled down again approximately to the temperature of the liquid medium in the temperature control channel 33. This cooled partial mass flow is then used to cool the electromotive drive with the stator 38 and the rotor 39 and a third component 73 to be temperature-controlled via the second temperature control path 62.

The third component to be temperature-controlled 73 is the radial bearing 9. The entire cooling mass flow is directed to the side of the gas supply apparatus 1 with the impeller 4. If the impeller 4 is designed as a turbine impeller, the mass flow is discharged into the environment. The impeller 4 can also be designed as a compressor wheel. In this case, it is advantageous to compress the gas mass flow again and feed it into the fuel cell system.

In FIG. 2, the gas temperature control ring 24 is shown in perspective on its own. The gas temperature control ring 24 comprises a collar 40 on the base body 29. In addition, the base body 29 has lamellar ribs 36 on the radially outer surface, which delimit the gas channels 22 running in the peripheral direction in the gas temperature control ring 24.

In addition, two inlet recesses 41, 43 and two outlet recesses 42, 44 are provided on the gas temperature control ring 24. A separating web 45 is formed on the gas temperature control ring 24 between the inlet recesses 41 and 43. Further separating webs 46, 47 are provided between the inlet recesses 41, 43 and the outlet recesses 42, 44.

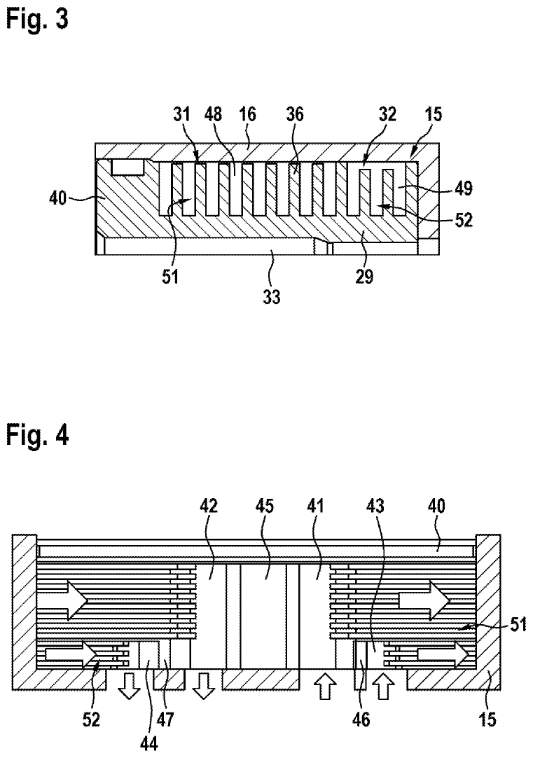

FIG. 3 shows the gas temperature control ring 24 from FIG. 2 in the housing 15 with the housing body 16. The lamellar ribs 36 delimit the first gas channels 48 in the first temperature control chamber 51. In the second temperature control chamber 52, the lamellar ribs 36 delimit second gas channels 49.

First pressure equalization gaps 31 are provided between the free ends of the lamellar ribs 36 in the first temperature control chamber 51 and the housing body 16. The first pressure equalization gaps 31 are smaller than the second pressure equalization gaps 32, which are located between the lamellar ribs 36 in the second temperature control chamber 52 and the housing body 16.

The number of lamellar ribs 36, which serve to represent a suitable cooling structure on the gas temperature control ring 24, is based on the required cooling capacity and a maximum permissible pressure drop. The height of the individual lamellar ribs 36 with the differently sized pressure equalization gaps 31 and 32 is also advantageously based on the required cooling capacity and the maximum permissible pressure drop.

The pressure equalization gaps 31, 32 between the free ends of the lamellar ribs 36 and the housing body 16 of the housing 15 are also referred to as head gaps. In the illustrated exemplary embodiment, the pressure equalization gaps 31, 32 are designed to be different sizes. The width of the lamellar ribs 36 can also be designed differently in the two temperature control chambers 51 and 52, unlike what is shown.

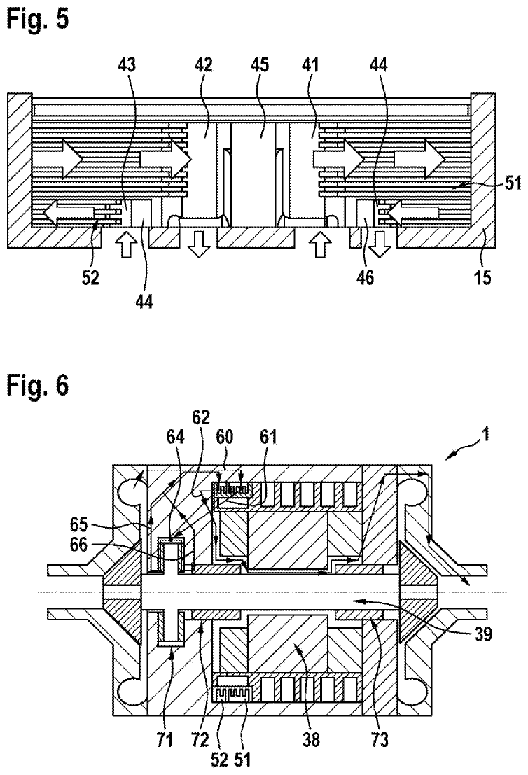

In FIGS. 4 and 5, vertical arrows illustrate how the gas is supplied axially to the temperature control chambers 51 and 52 and how it is discharged axially from the temperature control chambers 51, 52. The flow through the gas channels is in the same direction in FIG. 4. In FIG. 5, the two temperature control chambers 51, 52 are flowed through in opposite directions.

FIG. 6 shows an exemplary embodiment of the gas supply apparatus 1, in which the two partial paths 65, 66 of the first temperature control path 61 are fed together to the second temperature control chamber 52. Otherwise, the second temperature control path 62 runs as in the exemplary embodiment shown in FIG. 1b.

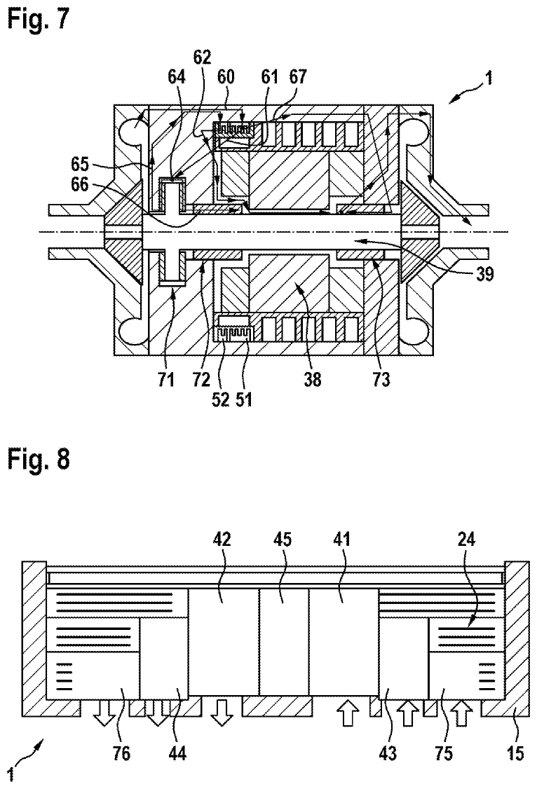

FIG. 7 shows an exemplary embodiment of the gas supply apparatus 1, in which a third partial path 67 from the first temperature control chamber 51 is guided from the left side of the gas supply apparatus 1 in FIG. 7 to the right side of the gas supply device 1. In this way, a gas mass flow guided through the third partial path 67 can be used to cool or control the temperature of the third component 73. The third component 73 is the radial bearing 9. After that, the third partial path 67 is combined with the second temperature control path 62.

FIG. 8 shows that the gas temperature control ring 24 can also be used to realize a three-stage or multi-stage temperature control. The gas supply apparatus 1 shown in FIG. 8 comprises, in addition to the two inlet recesses 41, 43 and the two outlet recesses 42, 44, a third inlet recess 75 and a third outlet recess 76.

1. A gas supply apparatus (1) with a shaft (7) rotatably mounted about an axis of rotation (13) in a housing (15) and having a temperature control device (11) which comprises a medium temperature control (12) which surrounds the shaft (7) and is combined with a gas temperature control means (20), wherein the gas temperature control means (20) comprises at least two temperature control chambers (51, 52) which are connected to one another via a first temperature control path (61) which is connected in a temperature-controlling manner to at least a first component (71) to be temperature-controlled.

2. The gas supply apparatus according to claim 1, wherein the first component (71) to be temperature-controlled comprises a thrust bearing (10) which is configured as a gas bearing.

3. The gas supply apparatus according to claim 1, wherein the at least two temperature control chambers (51, 52) are bounded by a common gas temperature control ring (24), along which a temperature control medium is guided radially on an inside.

4. The gas supply apparatus according to claim 3, wherein the at least two temperature control chambers (51, 52) comprise gas channels (22) which run in a circumferential direction radially on an outside of the gas temperature control ring (24) and are bounded axially by lamellar ribs (36) which are angled away from a circular-cylinder-casing-like base body (29) of the gas temperature control ring (24).

5. The gas supply apparatus according to claim 3, wherein the two temperature control chambers (51, 52) each comprise an inlet recess (41, 43) and an outlet recess (42, 44) which are connected via first (48) and second (49) gas channels.

6. The gas supply apparatus according to claim 5, wherein the gas temperature control ring (24) has separating webs (45, 46, 47) which delimit the inlet recesses (41, 43) and the outlet recesses (42, 44) and separate them from one another.

7. The gas supply apparatus according to claim 1, wherein the at least two temperature control chambers (51, 52) comprise a first temperature control chamber (51) which is connected to a gas pressure chamber (55) of the gas supply apparatus (1) via a gas supply path (60) and which is connected to a second temperature control chamber (52) via the first temperature control path (61), from which a second temperature control path (62) starts, which is connected in a temperature-controlling manner to at least one second component (72) to be temperature-controlled.

8. The gas supply apparatus according to claim 7, wherein the second temperature control path (61) runs between a rotor (39) and a stator (38) of the gas supply apparatus (1).

9. The gas supply apparatus according to claim 1, wherein the first temperature control path (61) has a branch (64), from which a first partial path (65) extends to the second temperature control chamber (52), wherein a second partial path (66) is connected, in a temperature-controlling manner, to at least one third component (73) to be temperature-controlled.

10. A gas temperature control ring (24), rotor (39), stator (38) and/or housing (15) for a gas supply apparatus (1) according to claim 1.
